(19) United States
(12) Patent Application Publication
(10) Pub. No.: US 2024/0355352 A1
(43) Pub. Date: Oct. 24, 2024

(54) SOUND SOURCE PROCESSING APPARATUS USING MAGNETIC DRUM

(71) Applicants: Sung-Do Chun, Anyang-si (KR); Ji Won Jun, Anyang-si (KR)

(72) Inventors: Sung-Do Chun, Anyang-si (KR); Ji Won Jun, Anyang-si (KR)

(21) Appl. No.: 18/684,665

(22) PCT Filed: Aug. 17, 2021
(86) PCT No.: PCT/KR2021/010872

§ 371 Date: Feb. 17, 2024

(51) Int. Cl. G11B 5/004; H03F 3/20

(52) U.S. Cl. CPC G11B 5/004; H03F 3/20

(57) ABSTRACT

A sound source processing apparatus uses a magnetic drum to prevent sound quality deterioration and amplify the volume of sound when a sound source transmitted from a primary acoustic device is outputted. The apparatus receives, through an input end, a sound source outputted from the primary acoustic device, records the inputted sound source on a recording part (a magnetic coating surface) of the magnetic drum in a magnetic drum recorder, reproduces, in real time, the sound source recorded on the magnetic drum, and then amplifies it, sequentially passing the amplified sound source through a pre-amplifier and a power amplifier to amplify output and then sending it to a speaker. To prevent sound quality deterioration for repetitive playback, interaction caused by contact between sound sources is removed. Amplifying the volume of sound outputted in real time using the magnetic drum promotes enhanced sound quality.

### TECHNICAL FIELD

The present invention relates to a sound source processing apparatus using a magnetic drum, in which sound source is recorded using a magnetic drum and then reproduced in real time so that the volume of sound is amplified by the magnetic drum, thereby improving sound quality during output.

### BACKGROUND ART

In general, a sound source processing device is used to receive a digital sound source signal and output the digital sound source signal as an analog sound source.

The sound processing device includes a first sound source reproducing device, which receives a digital sound source signal, converts the digital sound source signal into an analog sound source by using a digital to analog converter DAC, and amplifies and outputs the analog sound source as an analog sound source for playback, and a second sound source reproducing device, which receives a digital sound source signal, converts the digital sound source signal into an analog sound source by using a digital to analog converter DAC, records the converted analog sound source on a magnetic reel tape by using a magnetic record, and then reproduce the magnetic reel tape so that the sound source is amplified with an amplifier and then outputted through a speaker.

As shown in FIG. 1, the former first sound source reproducing device receives a digital sound source signal outputted from a digital device such as a PC, CD and MP3 through a digital sound source input terminal 11 of an input sound source processor 10, converts the digital sound source signal into an analog sound source through a digital/analog converter 12. Next, the converted analog sound source is pre-amplified through a pre-amplifier 20, and then an output of the analog sound source is amplified through a power amplifier 30. This amplified analog sound source is transmitted through a speaker 40.

This first sound source reproducing device is unable to record the inputted digital sound source, and can only reproduce the inputted sound source in real time.

As shown in FIG. 2, the latter second sound source reproducing device receives a digital sound source signal outputted from the digital device such as a PC, CD and MP3, converts the inputted digital sound source signal into an analog sound source at a digital/analog converter 12 of a sound source input terminal 50, and transmit the analog sound source to a magnetic recorder 60. The sound source inputted through a sound source input terminal 67 of the magnetic recorder 60 is recorded on a magnetic tape 65 wound on a magnetic reel 61 through a recording head 62. During playback, the sound source recorded on the magnetic tape 65 is reproduced and amplified through a reproducing head 64, and then outputted to a pre-amplifier 70 at a rear end through a sound source output terminal 66. Herein, the magnetic recorder 60 rotates the magnetic tape reel 61 through a motor drive unit 68 so as to transfer the magnetic tape 65. In addition, when erasing the sound source recorded on the magnetic tape 65, the sound source recorded on the magnetic tape 65 is erased through an erasing head 63. Next, the sound source amplified and outputted through the magnetic recorder 60 is pre-amplified through the pre-amplifier 70, and then a sound source output is amplified through a power amplifier 80. This amplified sound source is transmitted through a speaker 90.

However, when using this magnetic reel tape type magnetic recorder, it is possible to record a sound source that is transmitted from the outside, but it is impossible to reproduce the simply inputted sound source in real time. In addition, there is a problem in that the magnetic reel tape on which recording is made is likely to be damaged by magnetism and heat, resulting in loss of sound source information.

Furthermore, as the magnetic reel tape is played repeatedly, the length of the tape may be deformed and stretched due to the repeated play, causing deterioration, and this deterioration ultimately causes deterioration of sound quality.

In addition, the magnetic recorder has a complicated configuration, which causes inconvenience in storage and use.

Furthermore, the magnetic recorder has disadvantages in that when the recorded magnetic reel tape is left for a long period of time, the sound from both front and rear surfaces of the magnetic tape overlaps, causing deterioration of sound quality due to the influence of magnetic fields.

Meanwhile, another prior art using a magnetic recorder is disclosed in Korean Patent Publication No. 2000-0063635. The disclosed prior art provides a cassette tape type digital audio data playback device, which is equipped with a generator for generating electricity through the rotation of a reel.

However, since this prior art also uses a magnetic reel tape, there is also the problem that the magnetic reel tape is likely to be damaged by magnetism and heat, resulting in loss of sound source information. In addition, the length of the tape may be deformed and stretched due to the repeated play of the magnetic reel tape, causing the deterioration of sound quality, and the product size is large due to the complicated configuration, which causes inconvenience in storage and use. Furthermore, this prior art also has the disadvantages in that when the recorded magnetic reel tape is left for a long period of time, the sound from both front and rear surfaces of the magnetic tape overlaps, causing the deterioration of sound quality due to the influence of magnetic fields.

### PRIOR ART DOCUMENT

(Patent Document 1) Korean Patent Publication (Publication No. 10-2000-0063635, Publication Date: Nov. 16, 2000; Cassette tape type digital audio data playback device)

### DISCLOSURE OF THE INVENTION

### Technical Problem

Therefore, the present invention has been proposed to solve all the problems arising in the prior art of general magnetic reel tape recording as described above, and the purpose of the present invention is to provide a sound source processing apparatus using a magnetic drum, in which a sound source transmitted from an audio device is recorded using a magnetic drum and then produced in real time, thereby improving sound quality, when outputting the sound source, by preventing deterioration in sound quality and amplifying sound volume.

### Technical Solution

In order to achieve the purpose mentioned above, a “sound source processing apparatus using a magnetic drum” according to the present invention includes: a sound source input terminal; a magnetic drum recorder, which records sound source that is inputted through the sound source input terminal on a magnetic drum, reproduces the sound source recorded on the magnetic drum in real time, and then amplifies and outputs the sound source; a pre-amplifier for pre-amplifying the sound source amplified and outputted through the magnetic drum recorder; and a power amplifier, which amplifies output of the sound source pre-amplified through the pre-amplifier and then transmits the output of the sound source to a speaker.

The magnetic drum recorder includes: a recording head for recording the sound source that is inputted through the sound source input terminal on the magnetic drum; a reproducing head, which reproduces and amplifies the sound source recorded on the magnetic drum; an erasing head for erasing the sound source recorded on the magnetic drum; a sound source output terminal for outputting the sound source reproduced through the reproducing head; and a motor drive unit for rotating the magnetic drum by using a motor.

The magnetic drum has a recording part for recording the input sound source.

The recording part is provided on a surface of the magnetic drum.

The recording part is magnetically coated.

### Advantageous Effects of the Disclosure

According to the present invention, it is possible to record an inputted sound source and reproduce the sound source in real time through a simple structure, without using the magnetic recorder with the complicated structure employing a reel and a reel drive motor so as to transport a magnetic tape.

In addition, a magnetic drum with a magnetic coating surface is used instead of the magnetic tape, thereby preventing sound quality deterioration due to recording and repeated playback. In addition, there is no interaction between sound sources (no magnetic field effect), thereby preventing sound quality deterioration.

In addition, it has the advantage of recording sound source through the magnetic drum and amplifying the volume of sound by the magnetic drum during real-time playback, thereby improving sound quality.

### BRIEF DESCRIPTION OF DRAWINGS

FIG. 1 is a configuration diagram of a typical sound source reproducing device according to an embodiment,

FIG. 2 is a configuration diagram of a device for recording or reproducing an inputted sound source by using a conventional magnetic recorder according to an embodiment,

FIG. 3 is a block diagram of a sound source processing apparatus using a magnetic drum according to an embodiment of the present invention, and

FIG. 4a shows examples of digital sound source signal waveforms, FIG. 4b shows examples of waveforms of a sound source outputted after an inputted sound source is reproduced by a magnetic drum, and FIG. 4c shows examples of waveforms of sound source inputted to and outputted from a magnetic drum recorder according to the present invention.

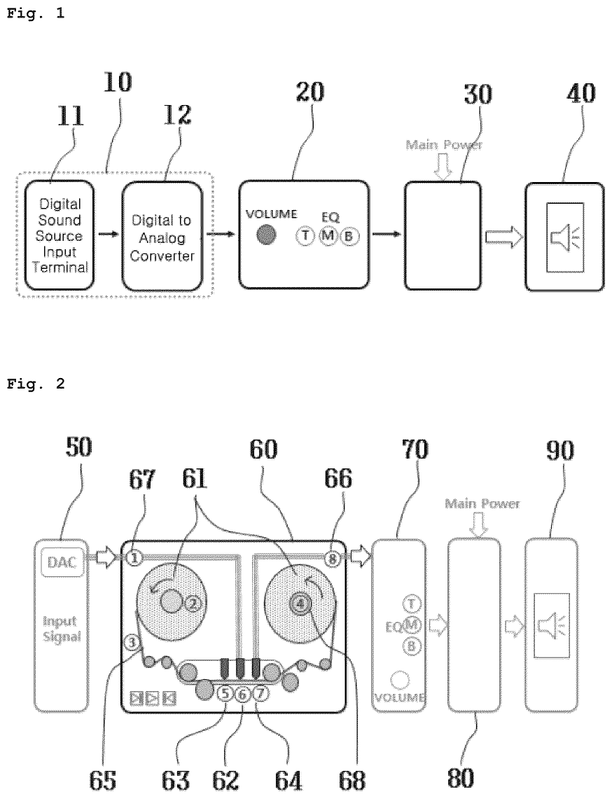

### EXPLANATION OF REFERENCE SIGNS

110: Sound source input terminal
111: Digital/analog converter DAC
120: Magnetic drum recorder
121: Sound source input terminal
122: Magnetic drum
123: Recording head
124: Reproducing head
125: Erasing head
126: Sound source output terminal
127: Motor drive unit
128: Recording part (magnetic coating surface)
130: Pre-amplifier
140: Power amplifier
150: Speaker

### MODE FOR INVENTION

Hereinafter, a sound source processing apparatus using a magnetic drum according to a preferred embodiment of the present invention will be described in detail with reference to the accompanying drawings.

Hereinafter, terms or words used herein should not be construed as limited to their usual or dictionary meanings, and should be interpreted as meanings and concepts consistent with the technical idea of the present invention based on the principle that the present inventors can appropriately define the concept of the terms in order to best explain the invention.

Therefore, the embodiments described herein and the configurations illustrated in the drawings are merely preferred embodiments of the present invention and do not represent the entire technical idea of the present invention, and it should be understood that various equivalents and modifications may exist.

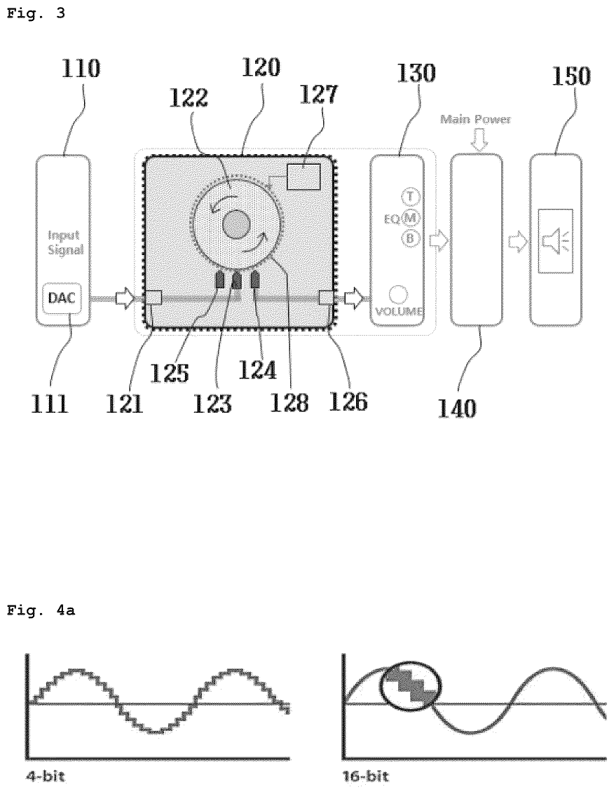

FIG. 3 is a configuration diagram of a sound source processing apparatus using a magnetic drum according to a preferred embodiment of the present invention, which includes a sound source input terminal 110, a magnetic drum recorder 120, a pre-amplifier 130, a power amplifier 140, and a speaker 150.

The sound source input terminal 110 is a primary audio device such as a PC, CD, or MP3 and may be called a sound source input terminal. This sound source input terminal 110 may include a digital/analog converter DAC 111 that converts an inputted digital sound source signal into an analog sound source.

The magnetic drum recorder 120 serves to record the sound source inputted through the sound source input terminal 110 on a magnetic drum, reproduces the analog sound source recorded on the magnetic drum in real time and then amplifies and outputs the analog sound source.

The magnetic drum recorder 120 may include a recording head 123 for recording the sound source, which is inputted from the sound source input terminal 110 through a sound source input terminal 121, on a recording part (a magnetic coating surface) 128 of a magnetic drum 122, a reproducing head 124, which reproduces and amplifies the sound source recorded on the magnetic drum 122, an erasing head 125 for erasing the sound source recorded on the magnetic drum 122, a sound source output terminal 126 for outputting the sound source reproduced through the reproducing head 124, and a motor drive unit 127 for rotating the magnetic drum 122 by using a motor.

The magnetic drum 122 has the recording part 128 for recording a sound source, and the recording part 128 is provided on entire surface of the magnetic drum 122. This recording part 128 is magnetically coated. Magnetic coating can be applied to the surface of the magnetic drum 122 in a manner similar to the magnetic coating treatment on general magnetic cards such as credit cards, check cards and transportation cards.

The pre-amplifier 130 serves to pre-amplify the sound source amplified and outputted through the magnetic drum recorder 120.

This pre-amplifier 130 may be implemented integrally with the magnetic drum recorder 120 or independently from the magnetic drum recorder 120. In the present invention, it is assumed that the pre-amplifier 130 is implemented independently from the magnetic drum recorder 120.

The power amplifier 140 serves to amplify output of the sound source pre-amplified through the pre-amplifier 130 and then transmits the sound source to the speaker 150.

Now, the operation of the sound source processing apparatus using a magnetic drum configured as described above according to the present invention will be described in detail hereinafter.

First, the sound source input terminal 110 receives sound source outputted from a primary audio device such as a PC, CD and MP3, and transmits the sound source to the magnetic drum recorder 120.

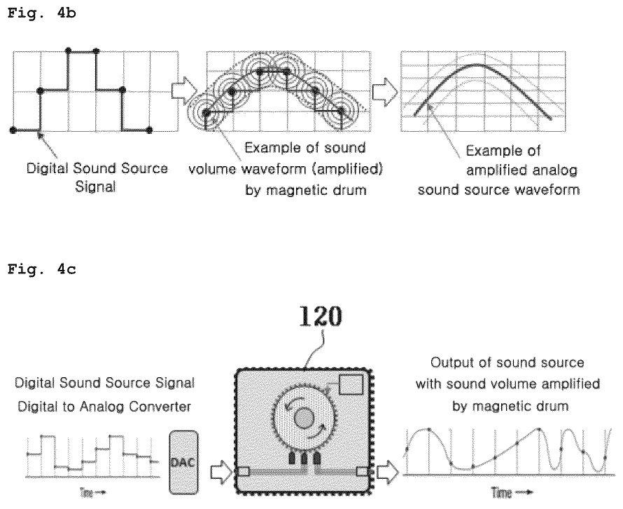

Referring to FIG. 4a, the left waveform is the waveform of a 4-bit digital sound source signal inputted to sound source input terminal 110, and the right waveform is the waveform of a 16-bit digital sound source signal.

The recording head 123 of the magnetic drum recorder 120 records the inputted sound source on the magnetic drum 122 in the same manner as the magnetic recording method of existing magnetic recorders.

Herein, the magnetic drum 122 has the recording part 128 provided on the surface thereof so as to record the sound source. The recording part 128 refers to the magnetic coating part. In other words, the surface of the magnetic drum 122 can be considered to be magnetically coated.

The magnetically coated recording part 128 can be said to have the same properties as magnetic tapes of the existing magnetic recorders.

When erasing the sound source recorded on the magnetic drum 122, the erasing head 125 erases the sound source recorded on the recording part 128 through a magnetic field erasing method in the same manner as erasing heads of the existing magnetic recorders.

Meanwhile, when reproducing the sound source recorded on the recording part 128, the reproducing head 124 reproduces and amplifies the sound source recorded on the recording part 128, which is the surface of the magnetic drum 122, in the same manner as reproducing heads of the existing magnetic recorders.

Herein, when recording, erasing, or reproducing sound source on the recording part 128 of the magnetic drum 122, the motor drive unit 127 rotates the magnetic drum 122 by appropriately rotating the motor under the control of a controller (not shown in the drawings).

The sound source reproduced through the reproducing head 124 has sound volume amplified by the magnetic drum, and is transmitted to the pre-amplifier 130 through the sound source output terminal 126.

Herein, the amplification of sound volume is intended to improve sound quality such as texture, density, and spatial impression.

In other words, as shown in FIG. 4b, the inputted digital sound source signal (left waveform) is converted into an analog sound source by the digital/analog converter and transmitted to the magnetic drum recorder 120. Then, the analog sound source is recorded on the magnetic drum 122. After that, when the analog sound source is reproduced in real time, sound volume is amplified (middle position waveform). The waveform on the right side of FIG. 4b shows a sound source waveform when outputting the sound source, which has improved sound quality by the amplification of the sound volume.

In this way, according to the present invention, the recording part is provided by treating the surface of the magnetic drum with the magnetic coating and the sound source is recorded on the surface of the magnetic drum. Therefore, even with repeated playback, deformation that occurs when using the magnetic tapes in the existing magnetic recorders does not occur, preventing deterioration in sound quality.

In addition, by implementing the sound source recording part by applying the magnetic coating only to the surface of the magnetic drum, contact between sound sources is prevented so that there is no mutual magnetic field influences caused by the contact between the sound sources, preventing sound quality deterioration even if the sound sources left for a long time.

As a result, this function of preventing sound quality deterioration can improve sound quality in magnetic sound source processing devices.

In addition, sound quality can be improved by recording the sound sources through the magnetic drum and amplifying the volume of the sound through the magnetic drum during real-time playback.

Next, the sound source amplified and outputted through the magnetic drum recorder 120 is pre-amplified through the pre-amplifier 130, and then sound source output is amplified through the power-amplifier 140. The sound source of which output is amplified in this way is transmitted through the speaker 150.

FIG. 4c shows examples of sound source output waveform, wherein a digital sound source signal is converted into an analog sound source by the digital/analog converter DAC and then recorded on the magnetic drum 120, and when reproduced in real time, the sound source is amplified and outputted since sound volume is amplified by the magnetic drum.

As shown in FIG. 4c, it can be seen that the sound source outputted from the primary audio device is recorded on the magnetic drum, and when reproduced, the sound source is outputted with sound volume amplified.

Although the invention derived by the present inventors has been described in detail according to the above embodiments, the present invention is not limited to the above embodiments, and it would be obvious to those skilled in the art that various changes can be made without departing from the gist of the invention.

What is claimed is:

1. A sound source processing apparatus using a magnetic drum, comprising:
a sound source input terminal for receiving sound source that is outputted from a primary audio device;
a magnetic drum recorder, which records sound source that is inputted through the sound source input terminal on a magnetic drum, reproduces the sound source recorded on the magnetic drum in real time, and then amplifies and outputs the sound source;
a pre-amplifier for pre-amplifying the sound source amplified and outputted through the magnetic drum recorder; and
a power amplifier, which amplifies output of the sound source pre-amplified through the pre-amplifier and then transmits the output of the sound source to a speaker,
wherein the magnetic drum recorder records an analog sound source signal inputted through the sound source input terminal on the magnetic drum, so that during playback, the sound source is amplified by the magnetic drum and volume of sound is amplified and outputted, and the magnetic drum has a recording part for recording sound source and the recording part is provided on entire surface of the magnetic drum so as to prevent magnetic field interaction due to contact between sound source.

2. The apparatus according to claim 1, wherein the magnetic drum recorder includes:
a recording head for recording the sound source that is inputted through the sound source input terminal on the magnetic drum;
a reproducing head, which reproduces and amplifies the sound source recorded on the magnetic drum;
an erasing head for erasing the sound source recorded on the magnetic drum;
a sound source output terminal for outputting the sound source reproduced through the reproducing head; and
a motor drive unit for rotating the magnetic drum by using a motor.

3. The apparatus according to claim 1, wherein the recording part is magnetically coated.
